(19) United States
(12) Patent Application Publication
(10) Pub. No.: US 2025/0252960 A1
(43) Pub. Date: Aug. 7, 2025

(54) LONGFORM WORD-LEVEL END-TO-END SPEAKER DIARIZATION WITH DYNAMIC AUDIO COHORT

(71) Applicant: Google LLC, Mountain View, CA (US)

(72) Inventors: Quan Wang, Hoboken, NJ (US); Yiling Huang, Edgewater, NJ (US); Guanlong Zhao, Long Island City, NY (US); Hank Liao, New York, NY (US); Weiran Wang, Iowa City, IA (US)

(73) Assignee: Google LLC, Mountain View, CA (US)

(21) Appl. No.: 19/042,106

(22) Filed: Jan. 31, 2025

Related U.S. Application Data
(60) Provisional application No. 63/548,764, filed on Feb. 1, 2024.

(51) Int. Cl. G10L 17/04; G10L 17/02; G10L 21/028

(52) U.S. Cl. CPC G10L 17/04; G10L 17/02; G10L 21/028

(57) ABSTRACT

A method includes obtaining a series of segmented labeled training samples. Each respective segmented labeled training sample includes one or more spoken terms spoken during a conversation by multiple speakers. Each respective spoken term is characterized by a corresponding sequence of acoustic frames and is paired with a corresponding transcription and a corresponding speaker label. For each respective segmented labeled training sample, the method includes obtaining a corresponding dynamic audio cohort associated with an immediately prior segmented labeled training sample, generating diarization results that include a corresponding speech recognition result having one or more predicted terms, and training a joint speech recognition and speaker diarization model based on a loss derived from the generated diarization results, the corresponding transcriptions, and the corresponding speaker labels.

### CROSS REFERENCE TO RELATED APPLICATIONS

This U.S. Patent Application claims priority under 35 U.S.C. § 119(e) to U.S. Provisional Application 63/548,764, filed on Feb. 1, 2024. The disclosure of this prior application is considered part of the disclosure of this application and is hereby incorporated by reference in its entirety.

### TECHNICAL FIELD

This disclosure relates to longform word-level end-to-end speaker diarization with dynamic audio cohort.

### BACKGROUND

Speaker diarization is the process of partitioning an input audio stream into homogeneous segments according to speaker identity. In an environment with multiple speakers, speaker diarization answers the question “who is speaking when” and has a variety of applications including multimedia information retrieval, speaker turn analysis, audio processing, and automatic transcription of conversation speech to name a few. For example, speaker diarization involves the task of annotating speaker turns in a conversation by identifying that a first segment of an input audio stream is attributable to a first human speaker (without particularly identifying who the first human speaker is), and a second segment of the input audio stream is attributable to a different second human speaker (without particularly identify who the second human speaker is), a third segment of the input audio stream is attributable to the first human speaker, etc.

### SUMMARY

One aspect of the disclosure provides a computer-implemented method executed on data processing hardware that causes the data processing hardware to perform operations for longform word-level end-to-end speaker diarization. The operations include obtaining a series of segmented labeled training samples. Each respective segmented labeled training sample including one or more spoken terms spoken during a conversation by multiple speakers. Each respective spoken term is characterized by a corresponding sequence of acoustic frames and is paired with a corresponding transcription of the respective spoken term and a corresponding speaker label representing an identity of a respective speaker that spoke the respective spoken term during the conversation. For each respective segmented labeled training sample, the operations include: obtaining a corresponding dynamic audio cohort associated with an immediately prior segmented labeled training sample, the corresponding dynamic audio cohort including a matrix of audio speech snippets of speakers that spoke prior to the respective segmented labeled training sample; generating, as output from a joint speech recognition and speaker diarization model, diarization results by performing cross-attention on the respective segmented labeled training sample and the corresponding dynamic audio cohort; generating an updated dynamic audio cohort based on the diarization results; and training the joint speech recognition and speaker diarization model based on a loss derived from the generated diarization results, the corresponding transcriptions, and the corresponding speaker labels. The diarization results include a corresponding speech recognition result including one or more predicted terms. Each respective predicted term is associated with a corresponding speaker token representing a predicted identity of a speaker that spoke the respective predicted term.

Implementations of the disclosure may include one or more of the following optional features. In some implementations, the matrix of audio speech snippets include audio-only data. In some examples, the matrix of audio speech snippets includes a predetermined number of slots for each speaker of the multiple speakers that spoke during the conversation. Each respective slot is configured to store a single audio speech snippet for a respective one of the multiple speakers. Here, each respective slot of the predetermined number of slots may be associated with a corresponding probability. In these examples, generating the updated dynamic audio cohort based on the diarization results includes determining that at least one of the one or more predicted terms of the corresponding speech recognition result was spoken by a new speaker that did not speak during any previous segmented labeled training sample, sampling the corresponding sequence of acoustic frames characterizing the at least one of the one or more predicted terms based on determining that the at least one of the one or more predicted terms of the corresponding speech recognition result was spoken by the new speaker, and storing the sampled corresponding sequence of acoustic frames as a respective audio speech snippet for the new speaker at one of the predetermined number of slots for the new speaker.

Alternatively, generating the updated dynamic audio cohort based on the diarization results may include determining that at least one of the one or more predicted terms of the corresponding speech recognition result was spoken by a respective speaker that did speak during a previous segmented labeled training sample, determining that a current number of audio speech snippets stored for the respective speaker fails to satisfy a threshold of audio speech snippets, sampling the corresponding sequence of acoustic frames characterizing the at least one of the one or more predicted terms based on determining that the current number of snippets stored for the respective speaker fails to satisfy the threshold of audio speech snippets, and storing the sampled corresponding sequence of acoustic frames as a respective audio snippet for the respective speaker at one of the predetermined number of slots. In these examples, generating the updated dynamic audio cohort based on the diarization results may include determining that at least one of the one or more predicted terms of the corresponding speech recognition result was spoken by a respective speaker that did speak during a previous segmented labeled training sample, determining that a current number of snippets stored for respective speaker satisfies a threshold of audio speech snippets, and sampling a random number from a random number distribution based on determining that the current number of snippets stored for respective speaker satisfies the threshold of audio speech snippets.

Here, generating the updated dynamic audio cohort based on the diarization results may include determining that the sampled random number satisfies a random number threshold and, based on determining that the sampled random number satisfies the random number threshold, identifying a respective one of the predetermined number of slots associated with the respective speaker based on the sampled random number, sampling the corresponding sequence of acoustic frames characterizing the at least one of the one or more predicted terms, and replacing a respective audio speech snippet stored at the identified respective one of the predetermined number of slots with the sampled corresponding sequence of acoustic frames as a new respective audio snippet. Generating the updated dynamic audio cohort based on the diarization results may include determining that the sampled random number fails to satisfy a random number threshold and determining not to replace any of the audio speech snippets currently stored in association with the respective speaker based on determining that the sampled random number fails to satisfy the random number threshold. In some implementations, the operations further include augmenting each segmented labeled training sample.

Another aspect of the disclosure provides a system that includes data processing hardware and memory hardware storing instructions that when executed on the data processing hardware causes the data processing hardware to perform operations. The operations include obtaining a series of segmented labeled training samples. Each respective segmented labeled training sample including one or more spoken terms spoken during a conversation by multiple speakers. Each respective spoken term is characterized by a corresponding sequence of acoustic frames and is paired with a corresponding transcription of the respective spoken term and a corresponding speaker label representing an identity of a respective speaker that spoke the respective spoken term during the conversation. For each respective segmented labeled training sample, the operations include: obtaining a corresponding dynamic audio cohort associated with an immediately prior segmented labeled training sample, the corresponding dynamic audio cohort including a matrix of audio speech snippets of speakers that spoke prior to the respective segmented labeled training sample; generating, as output from a joint speech recognition and speaker diarization model, diarization results by performing cross-attention on the respective segmented labeled training sample and the corresponding dynamic audio cohort, generating an updated dynamic audio cohort based on the diarization results; and training the joint speech recognition and speaker diarization model based on a loss derived from the generated diarization results, the corresponding transcriptions, and the corresponding speaker labels. The diarization results include a corresponding speech recognition result including one or more predicted terms. Each respective predicted term is associated with a corresponding speaker token representing a predicted identity of a speaker that spoke the respective predicted term.

Implementations of the disclosure may include one or more of the following optional features. In some implementations, the matrix of audio speech snippets include audio-only data. In some examples, the matrix of audio speech snippets includes a predetermined number of slots for each speaker of the multiple speakers that spoke during the conversation. Each respective slot is configured to store a single audio speech snippet for a respective one of the multiple speakers. Here, each respective slot of the predetermined number of slots may be associated with a corresponding probability. In these examples, generating the updated dynamic audio cohort based on the diarization results includes determining that at least one of the one or more predicted terms of the corresponding speech recognition result was spoken by a new speaker that did not speak during any previous segmented labeled training sample, sampling the corresponding sequence of acoustic frames characterizing the at least one of the one or more predicted terms based on determining that the at least one of the one or more predicted terms of the corresponding speech recognition result was spoken by the new speaker, and storing the sampled corresponding sequence of acoustic frames as a respective audio speech snippet for the new speaker at one of the predetermined number of slots for the new speaker.

Alternatively, generating the updated dynamic audio cohort based on the diarization results may include determining that at least one of the one or more predicted terms of the corresponding speech recognition result was spoken by a respective speaker that did speak during a previous segmented labeled training sample, determining that a current number of audio speech snippets stored for the respective speaker fails to satisfy a threshold of audio speech snippets, sampling the corresponding sequence of acoustic frames characterizing the at least one of the one or more predicted terms based on determining that the current number of snippets stored for the respective speaker fails to satisfy the threshold of audio speech snippets, and storing the sampled corresponding sequence of acoustic frames as a respective audio snippet for the respective speaker at one of the predetermined number of slots. In these examples, generating the updated dynamic audio cohort based on the diarization results may include determining that at least one of the one or more predicted terms of the corresponding speech recognition result was spoken by a respective speaker that did speak during a previous segmented labeled training sample, determining that a current number of snippets stored for respective speaker satisfies a threshold of audio speech snippets, and sampling a random number from a random number distribution based on determining that the current number of snippets stored for respective speaker satisfies the threshold of audio speech snippets.

Here, generating the updated dynamic audio cohort based on the diarization results may include determining that the sampled random number satisfies a random number threshold and, based on determining that the sampled random number satisfies the random number threshold, identifying a respective one of the predetermined number of slots associated with the respective speaker based on the sampled random number, sampling the corresponding sequence of acoustic frames characterizing the at least one of the one or more predicted terms, and replacing a respective audio speech snippet stored at the identified respective one of the predetermined number of slots with the sampled corresponding sequence of acoustic frames as a new respective audio snippet. Generating the updated dynamic audio cohort based on the diarization results may include determining that the sampled random number fails to satisfy a random number threshold and determining not to replace any of the audio speech snippets currently stored in association with the respective speaker based on determining that the sampled random number fails to satisfy the random number threshold. In some implementations, the operations further include augmenting each segmented labeled training sample.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system that executes a joint speech recognition and speaker diarization model.

FIG. 2 is a schematic view of an example automatic speech recognition model.

FIGS. 3A and 3B are schematic views of exemplary joint networks of the joint speech recognition and speaker diarization model.

FIG. 4 is a schematic view of an example training process for training the joint speech recognition and speaker diarization model.

FIG. 5 is a schematic view of an example dynamic audio cohort.

FIG. 6 is a flowchart of an example arrangement of operations for a computer-implemented method of training an end-to-end speaker diarization model with a dynamic audio cohort.

FIG. 7 is a schematic view of an example computing device that may be used to implement the systems and methods described herein.

Like reference symbols in the various drawings indicate like elements.

### DETAILED DESCRIPTION

Automatic speech recognition (ASR) systems generally rely on speech processing algorithms that assume only one speaker is speaking in a given input audio signal. An input audio signal that includes a presence of multiple speakers can potentially disrupt these speech processing algorithms, thereby leading to inaccurate speech recognition results output by the ASR systems. As such, speaker diarization is the process of segmenting speech from a same speaker in a larger conversation not to specifically determine who is talking (speaker recognition/identification), but rather, determine when someone is speaking. Put another way, speaker diarization includes a series of speaker recognition tasks with short utterances that determines whether two segments of a given conversation were spoken by the same speaker or different speakers, and is repeated for all segments of the conversation. Accordingly, speaker diarization detects speaker turns from a conversation that includes multiple speakers. As used herein, the term ‘speaker turn’ refers to the transition from one individual speaking to a different individual speaking in a larger conversation.

Existing speaker diarization systems generally include multiple relatively independent components, such as, without limitation, a speech segmentation module, an embedding extraction module, and a clustering module. The speech segmentation module is generally configured to remove non-speech parts from an input utterance and divide the entire input utterance into fixed-length segments. Although dividing the input utterance into fixed-length segments is easy to implement, oftentimes, it is difficult to find a good segment length. That is, long fixed-length segments may include several speaker turns, while short segments include an insufficient number of speaker turns. The embedding extraction module is configured to extract, from each segment, a corresponding speaker-discriminative embedding. The speaker-discriminative embedding may include i-vectors or d-vectors. The clustering modules are tasked with determining the number of speakers present in the input utterance and assigning speaker identities (i.e., labels) to each segment. These clustering modules may use popular clustering algorithms that include Gaussian mixture models, mean shift clustering, agglomerative hierarchical clustering, k-means clustering, links clustering, and spectral clustering.

One significant drawback of these existing speaker diarization systems is that the speaker-discriminative embeddings are not representative of speech variations of speakers throughout a conversation. For example, at the beginning of an hour-long interview, a speaker may be nervous and speak differently than at the end of the interview when that same speaker speaks more comfortably. In this example, existing speaker diarization systems may simply store a speaker-discriminative embedding representing the voice of the speaker during the beginning of the interview or the last time the speaker spoke, and thus, may not be able to accurately identify that same speaker speaking more comfortably later in the interview. Another significant drawback of these existing speaker diarization systems is that some regulations preclude diarization systems from computing speaker-discriminative embeddings of any kind, let alone storing and using speaker-discriminative embeddings to perform speaker diarization.

Accordingly, implementations herein are directed towards methods and systems of a training process that trains a word-level end-to-end speaker diarization model with a dynamic audio cohort. In particular, the training process obtains a series of segmented labeled training samples. Each respective segmented labeled training sample includes one or more spoken terms spoken during a conversation by multiple speakers. Moreover, each respective spoken term is characterized by a corresponding sequence of acoustic frames and is paired with a corresponding transcription of the respective spoken term and a corresponding speaker label representing an identity of a respective speaker that spoke the respective spoken term during the conversation. For each respective segmented labeled training sample, the training process obtains a corresponding dynamic audio cohort associated with an immediately prior segmented labeled training sample and generates diarization results by performing cross-attention on the respective segmented labeled training sample. Moreover, for each segmented labeled training sample, the training process generates an updated dynamic audio cohort based on the diarization results and trains a joint speech recognition and speaker diarization model based on a loss derived from the generated diarization results, the corresponding transcriptions, and the corresponding speaker labels. Notably, the corresponding dynamic audio cohort includes a matrix of audio speech snippets of speakers that spoke prior to the respective segmented labeled training sample. That is, the dynamic audio cohort includes audio data and not speaker embeddings. As will become apparent, the dynamic audio cohort is dynamically updated so as to adequately represent speech variations of each speaker of the multiple speakers throughout the entire conversation.

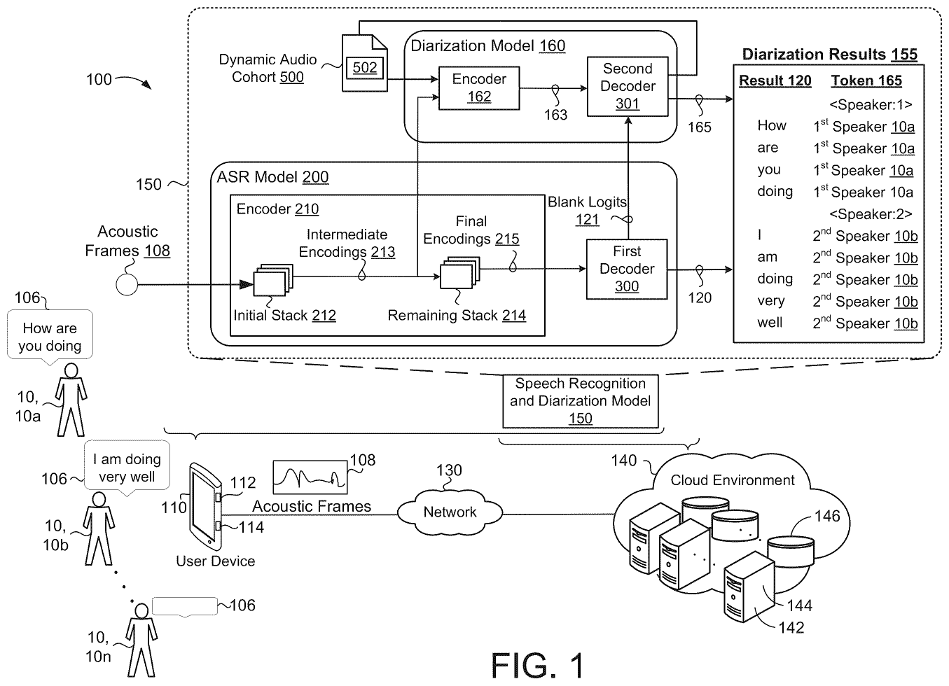

Referring to FIG. 1, a system 100 includes a user device 110 capturing speech utterances 106 spoken by multiple speakers (e.g., users) 10, 10a-n during a conversation and communicating with a remote system 140 via a network 130. The remote system 140 may be a distributed system (e.g., cloud computing environment) having scalable/elastic resources 142. The resources 142 include computing resources 144 (e.g., data processing hardware) and/or storage resources 146 (e.g., memory hardware). The user device 110 and/or the remote system 140 executes a joint speech recognition and speaker diarization model 150 that is configured to receive a sequence of acoustic frames 108 that corresponds to captured speech utterances 106 spoken by the multiple speakers 10 during the conversation and generates, at each of a plurality of output steps, speech recognition results (e.g., speech recognition hypotheses or transcriptions) 120 corresponding to the captured speech utterances 106 and diarization results 155. As will become apparent, the speech recognition results 120 indicate “what” was spoken during the conversation and the diarization results 155 indicate “who” spoke each word/wordpiece of the speech recognition results 120. Notably, the diarization results 155 include word-level results that represent who spoke each word/wordpiece rather than frame-level results that represent who was speaking during each frame of the sequence of acoustic frames 108.

The user device 110 includes data processing hardware 112 and memory hardware 114. The user device 110 may include an audio capture device (e.g., microphone) for capturing and converting the speech utterances 106 (also referred to as simply “utterances 106”) from the multiple speakers 10 into the sequence of acoustic frames 108 (e.g., input audio data). In some implementations, the user device 110 is configured to execute a portion of the joint speech recognition and speaker diarization model 150 locally (e.g., using the data processing hardware 112) while a remaining portion of the joint speech recognition and speaker diarization model 150 executes on the cloud computing environment 140 (e.g., using data processing hardware 144). Alternatively, the joint speech recognition and speaker diarization model 150 may execute entirely on the user device 110 or cloud computing environment 140. The user device 110 may be any computing device capable of communicating with the cloud computing environment 140 through the network 130. The user device 110 includes, but is not limited to, desktop computing devices and mobile computing devices, such as laptops, tablets, smart phones, smart speakers/displays, smart appliances, internet-of-things (IoT) devices, and wearable computing devices (e.g., headsets and/or watches).

In the example shown, the multiple speakers 10 and the user device 110 may be located within an environment (e.g., a room) where the user device 110 is configured to capture and convert the speech utterances 106 spoken by the multiple speakers 10 into the sequence of acoustic frames 108. For instance, the multiple speakers 10 may correspond to co-workers having a conversation during a meeting and the user device 110 may record and convert the speech utterances 106 into the sequence of acoustic frames 108. In turn, the user device 110 may provide the sequence of acoustic frames 108 to the joint speech recognition and speaker diarization model 150 to generate speech recognition results 120 and diarization results 155. In other examples, the sequence of acoustic frames 108 corresponds to a video or audio file of a conversation with multiple speakers. In these other examples, the sequence of acoustic frames 108 may be stored on the memory hardware 114, 146 of the user device 110 and/or the cloud computing environment 140.

In some examples, at least a portion of the speech utterances 106 conveyed in the sequence of acoustic frames 108 are overlapping such that, at a given instant in time, two or more speakers 10 are speaking simultaneously. Notably, a number N of the multiple speakers 10 may be unknown when the sequence of acoustic frames 108 are provided as input to the joint speech recognition and speaker diarization model 150 whereby the joint speech recognition and speaker diarization model 150 predicts the number N of the multiple speakers 10. In some implementations, the user device 110 is remotely located from the one or more of the multiple speakers 10. For instance, the user device 110 may include a remote device (e.g., network server) that captures speech utterances 106 from the multiple speakers 10 that are participants in a phone call or video conference. In this scenario, each speaker 10 would speak into their own user device 110 (e.g., phone, radio, computer, smartwatch, etc.) that captures and provides the speech utterances 106 to the remote user device for converting the speech utterances 106 into the sequence of acoustic frames 108. Of course in this scenario, the speech utterances 106 may undergo processing at each of the user devices 110 and be converted into a corresponding sequence of acoustic frames 108 that are transmitted to the remote user device which may additionally process the sequence of acoustic frames 108 provided as input to the joint speech recognition and speaker diarization model 150.

In the example shown, the joint speech recognition and speaker diarization model 150 includes an automatic speech recognition (ASR) model 200 that has an audio encoder 210 and a first decoder 300, and a diarization model 160 that has a diarization encoder 162 and a second decoder 301. Notably, the first decoder 300 is independent and separate from the second decoder 301. That is, the first decoder 300 includes a respective set of parameters and the second decoder 301 includes a different respective set of parameters. Here, only two speakers (e.g., a first speaker 10, 10a and a second speaker 10, 10b) are participating in the conversation for the sake of clarity only, as it is understood that any number of speakers 10 may speak during the conversation. In the example shown, the first speaker 10a speaks “how are you doing” and the second speaker 10b responds by speaking “I am doing very well.” The ASR model 200 is configured to generate the speech recognition results 120 representing “what” was spoken by the multiple speakers 10 during the conversation based on the sequence of acoustic frames 108.

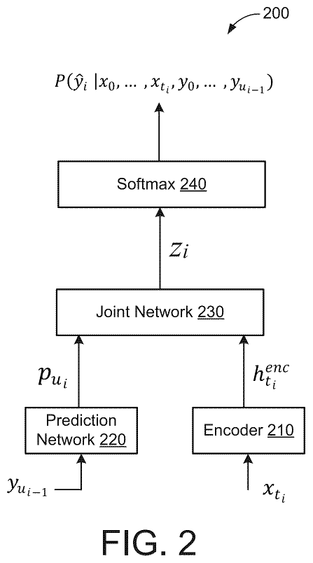

Referring now to FIG. 2, in some implementations, the ASR model 200 includes a Recurrent Neural Network-Transducer (RNN-T) model architecture which adheres to latency constraints with interactive applications. The use of the RNN-T model architecture is exemplary only, as the ASR model 200 may include other architectures such as transformer-transducer and conformer-transducer model architectures, among others. The RNN-T model 200 provides a small computational footprint and utilizes less memory requirements than conventional ASR architectures, making the RNN-T model architecture suitable for performing speech recognition entirely on the user device 110 (e.g., no communication with a remote server is required). The RNN-T model 200 includes an encoder network (e.g., audio encoder) 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, audio encoder 210 reads a sequence of d-dimensional feature vectors (e.g., acoustic frames 108 (FIG. 1)) x=(x₁, x₂, . . . , x_{T}), where xₜ∈ [symbol] _{d}, and produces at each output step a higher-order feature representation (e.g., audio encoding). This higher-order feature representation is denoted as h₁^{enc}, . . . , h_{T}^{enc}.

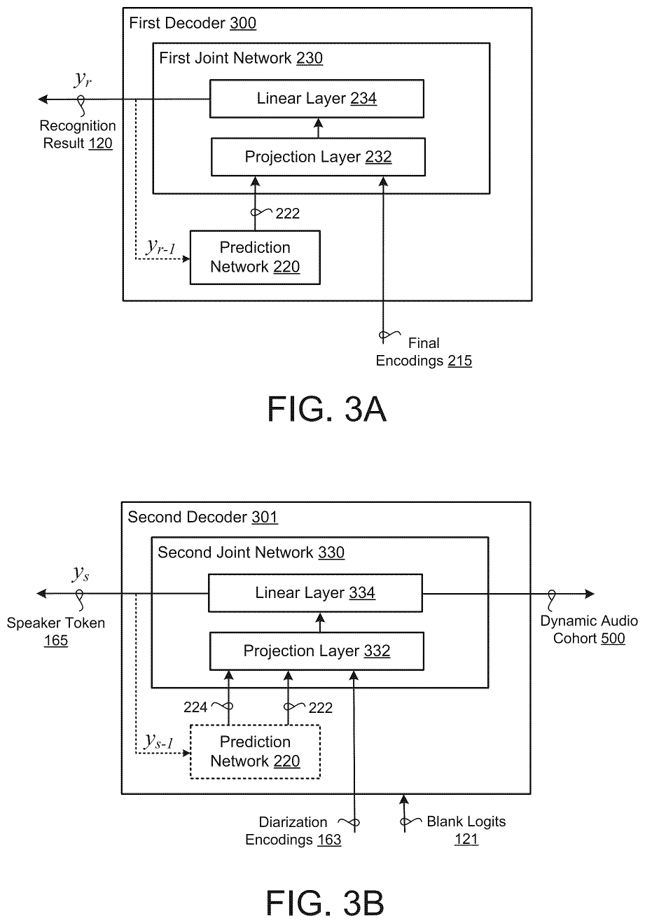

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Described in greater detail with reference to FIG. 3A, the prediction network 220 and the joint network 230 may collectively form the first decoder 300 of FIG. 1 that includes an RNN-T architecture. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network 230 then predicts P(ŷᵢ|x₀, . . . , y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the speech recognition result (e.g., transcription) 120 (FIG. 1).

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics, but also on the sequence of labels output so far. The RNN-T model 200 does assume an output symbol is independent of future acoustic frames 108, which allows the RNN-T model to be employed in the streaming fashion, the non-streaming fashion, or some combination thereof.

In some examples, the audio encoder 210 of the RNN-T model includes a plurality of multi-head (e.g., 8 heads) self-attention layers. For example, the plurality of multi-head self-attention layers may include Conformer layers (e.g., Conformer-encoder), transformer layers, performer layers, convolution layers (including lightweight convolution layers), or any other type of multi-head self-attention layers. The plurality of multi-head self-attention layers may include any number of layers, for instance, 16 layers. Moreover, the audio encoder 210 may operate in the streaming fashion (e.g., the audio encoder 210 outputs initial higher-order feature representations as soon as they are generated), in the non-streaming fashion (e.g., the audio encoder 210 outputs subsequent higher-order feature representations by processing additional right-context to improve initial higher-order feature representations), or in a combination of both the streaming and non-streaming fashion.

Referring back to FIG. 1, in some examples, the audio encoder 210 includes a stack of audio encoder layers 212, 214 having multi-head self-attention layers (e.g., conformer, transformer, convolutional, or performer layers) or a recurrent network of Long Short-Term Memory (LSTM) layers. For instance, the audio encoder 210 receives, as input, the sequence of acoustic frames 108 and generates, at each of the plurality of output steps, corresponding audio encoding 213, 215. More specifically, an initial stack of audio encoder layers 212 generates, at each output step, a corresponding sequence of intermediate audio encodings 213 from the sequence of acoustic frames 108. Thereafter, a remaining stack of the audio encoder layers 214 generates, at each output step, a corresponding sequence of final audio encodings 215 from the sequence of intermediate audio encodings 213. For example, the stack of audio encoder layers 212, 214 may include sixteen (16) conformer layers where the initial stack of audio encoder layers 212 (e.g., four (4) conformer layers) generates the corresponding sequence of intermediate audio encodings 213 from the sequence of acoustic frames 108 and the remaining stack of audio encoder layers 214 (e.g., the remaining twelve (12) conformer layers) generates the corresponding sequence of final audio encodings 215 from the corresponding sequence of intermediate audio encodings 213.

Notably, some information is discarded (e.g., background noise) as the initial stack of audio encoder layers 212 generates the sequence of intermediate audio encodings 213, but speaker characteristic information is maintained. Here, speaker characteristic information refers to the speaking traits or style of a particular user, for example, prosody, accent, dialect, cadence, pitch, etc. However, after generating the intermediate audio encodings 213, the speaker characteristic information may also be discarded as the remaining stack of audio encoder layers 214 generates the sequence of final audio encodings 215. That is, because the ASR model 200 is configured to predict “what” was spoken, the remaining stack of audio encoder layers 214 may filter out the speaker characteristic information (e.g., indicating voice characteristics of the particular user speaking) because voice characteristics pertaining to particular speakers are not needed to predict “what” was spoken and are only relevant when predicting “who” is speaking.

On the other hand, the diarization model 160 may leverage the speaker characteristic information to improve accuracy of predicting “who is speaking when,” because voice characteristics pertaining to particular speakers is helpful information when identifying who is speaking. Thus, because the sequence of intermediate audio encodings 213 includes the speaker characteristic information from the sequence of acoustic frames 108 (e.g., that may be subsequently discarded by the remaining stack of audio encoder layers 214), the intermediate audio encodings 213 advantageously enable the diarization model 160 to more accurately predict who is speaking each term (e.g., word, wordpiece, grapheme, etc.) of the speech recognition results 120. The first decoder 300 of the ASR model 200 is configured to receive, as input, the sequence of final audio encodings 215 generated by the remaining stack of audio encoder layers 214 and generate, at each of the plurality of output steps, a corresponding speech recognition result 120. The speech recognition result 120 may include a probability distribution over possible speech recognition hypotheses (e.g., words, wordpieces, graphemes, etc.) whereby the diarization results 155 are word-level, wordpiece-level, or grapheme-level results. In some examples, the speech recognition results 120 include blank logits 121 denoting that no terms are currently being spoken at the corresponding output step. As will become apparent, the first decoder 300 may output the blank logits 121 and/or the speech recognition results 120 (not shown) to the second decoder 301 such that the second decoder 301 only outputs speaker tokens when the first decoder 300 outputs non-blank speech recognition hypotheses 120.

Referring now to FIG. 3A, the first decoder 300 may include a RNN-T decoder architecture having the first joint network 230 and the prediction network 220. The first decoder 300 uses the first joint network 230 to combine the sequence of final audio encodings 215 generated by the remaining stack of audio encoder layers 214 (FIG. 1) and an audio embedding output 222 generated by the prediction network 220 for the previous prediction yᵣ₋₁ to generate the speech recognition result 120. The speech recognition result 120 may be a probability distribution, P (yᵢ|yᵢ₋₁, . . . , y₀, x), over the current sub-word unit, yᵢ, given the sequence of the N previous non-blank symbols previous units, {yᵢ₋₁, . . . , y_{i-N}}, and the input of the sequence of final audio encodings 215. In some examples, the first joint network 230 includes a first projection layer 232 that applies a projection and addition activation to combine the sequence of final audio encodings 215 and the audio embedding output 222, and a first linear layer 234 that applies a hyperbolic tangent function (Tan h) and a linear activation on the output of the first projection layer 232 to generate the speech recognition result 120. Although not illustrated, in some examples, the first decoder 300 includes a Softmax layer (e.g., Softmax layer 240 (FIG. 2)) that receives the output of the first decoder 300. In some implementations, the Softmax layer is separate from the first decoder 300 and processes the output, yᵣ, from the first decoder 300. Thus, the output of the Softmax layer is then used in a beam search process to select orthographic elements to generate the speech recognition result 120. In some implementations, the Softmax layer is integrated with the first decoder 300, such that the output yᵣ of the first decoder 300 represents the output of the Softmax layer.

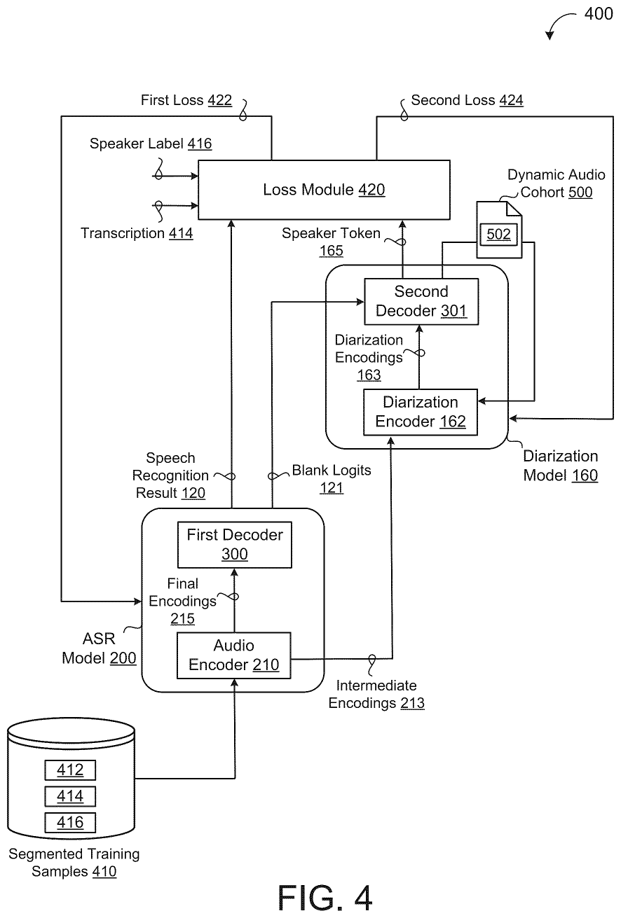

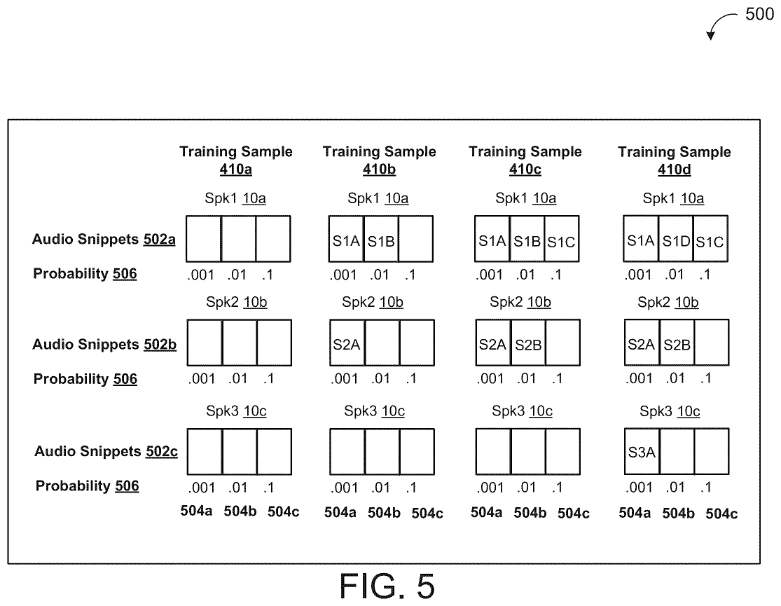

Referring back to FIG. 1, the diarization model 160 is configured to generate, for each speech recognition result 120 generated by the first decoder 300 of the ASR model 200, a respective speaker token 165 representing a predicted identity of a speaker 10 from the multiple speakers 10 speaking during the conversation. Thus, the respective speaker tokens 165 generated by the diarization model 160 are word-level, wordpiece-level, or grapheme-level in connection with the ASR model 200 generating word-level, wordpiece-level, or grapheme-level speech recognition results 120, respectively. In particular, the diarization encoder 162 of the diarization model 160 receives, as input, the sequence of intermediate audio encodings 213 generated by the initial stack of audio encoder layers 212 and a corresponding dynamic audio cohort 500 and generates, at each of the plurality of output steps, a corresponding sequence of diarization encodings 163 based on the sequence of the intermediate audio encodings 213 and the corresponding dynamic audio cohort 166. Notably, as discussed above, the sequence of intermediate audio encodings 213 may retain speaker characteristic information associated with the speaker 10 that is currently speaking to predict the identity of the speaker 10. The corresponding dynamic audio cohort 500 is associated with an immediately prior output step of the plurality of output steps during inference. Discussed in greater detail with reference to FIGS. 4 and 5, the corresponding dynamic audio cohort 500 includes a matrix of audio speech snippets 502 of speakers 10 that spoke prior to the current output step, and thus, the diarization encoder 162 performs cross-attention between the sequence of intermediate audio encodings 213 and the corresponding dynamic audio cohort 500 to generate the diarization encodings 163.

Moreover, the diarization encoder 162 includes a memory unit that stores the previously generated dynamic audio cohort 500 generated at prior output steps during the conversation. The memory unit may include the memory hardware 114 from the user device 110 and/or the memory hardware 146 from the cloud computing environment 140. In particular, the diarization model 160 may include a recurrent neural network that has a stack of long short-term memory (LSTM) layers or a stack of multi-headed self-attention layers (e.g., conformer layers or transformer layers). Here, the stack of LSTM layers or multi-head self-attention layers act as the memory unit and store the dynamic audio cohort 500. As such, the diarization encoder 162 may generate, for a current output step, a corresponding diarization encoding 163 by performing cross attention between the sequence of intermediate audio encodings 213 and the previously generated dynamic audio cohort 500. Advantageously, using the dynamic audio cohort 500 provides the diarization model 160 more context in predicting which particular speaker 10 is currently speaking based on previous words the particular speaker 10 may have spoken during the conversation. In some implementations, the diarization model 160 includes a plurality of diarization encoders 162 (e.g., K number of diarization encoders) (not shown) whereby K is equal to the number speakers 10 speaking during the conversation. Stated differently, each diarization encoder 162 of the K number of diarization encoders 162 may be assigned to a particular one of the speakers 10 from the conversation. Moreover, each diarization encoder 162 of the K number of diarization encoders 162 is configured to receive a Kth intermediate audio encoding 213 from the audio encoder 210. Here, each of the Kth intermediate audio encodings 213 is associated with a respective one of the speakers 10 and is output to a corresponding diarization encoder 162 associated with the respective one of the speakers 10.

Thereafter, the second decoder 301 receives the sequence of diarization encodings 163 generated by the diarization encoder 162 and generates, for each respective speech recognition result 120 output by the ASR model 200, the respective speaker token 165 representing a predicted identity of the speaker 10 from the multiple speakers 10 that spoke the corresponding term from the speech recognition results 120. That is, the ASR model 200 may output speech recognition results 120 at each output step of the plurality of output steps such that the speech recognition results 120 include blank logits 121 where no speech is currently present. In contrast, the second decoder 301 is configured to receive the blank logits 121 and/or speech recognition results 120 (not shown) from the ASR model 200 whereby the second decoder 301 only generates speaker tokens 165 when the ASR model 200 generates speech recognition results 120 that include a spoken term. For example, for a conversation that includes ten (10) words, the second decoder 301 generates a corresponding ten (10) speaker tokens 165 (e.g., one speaker token for each word recognized by the ASR model 200). Moreover, the second decoder 301 generates an updated dynamic audio cohort 500 based on the speaker tokens 165 generated at the current output step. Thus, the diarization model 160 uses the updated dynamic audio cohort 500 for processing at a subsequent output step.

Referring now to FIG. 3B, the second decoder 301 may include a RNN-T architecture having a second joint network 330. Optionally, the second decoder 301 may include the prediction network 220 (e.g., denoted by dotted lines) that is shared with the first decoder 300 (FIG. 3A). The second decoder 301 uses the second joint network 330 to process the sequence of diarization encodings 163 generated by the diarization encoder 162 of the diarization model 160 (FIG. 1) to generate the speaker token 165 and the updated dynamic audio cohort 500. When the second decoder 301 includes the prediction network 220, the second joint network 330 combines the sequence of diarization encodings 163 with the audio embedding output 222 generated by the prediction network 220 for the previous prediction yᵣ₋₁ (FIG. 3A) and/or a token embedding output 224 generated by the prediction network 220 for the previous prediction yₛ₋₁ to generate the speaker token 165. In some examples, the second joint network 330 includes a second projection layer 332 that applies a projection and addition activation on the sequence of diarization encodings 163, the audio embedding output 222, and/or the token embedding output 224 and a second linear layer 334 that applies a hyperbolic tangent function (Tan h) and a linear activation on the output of the second projection layer 332 to generate the speaker token 165. Although not illustrated, the second decoder 301 may include a Softmax layer that receives the output of the second decoder 301. In some implementations, the Softmax layer is separate from the second decoder 301 and processes the output, yₛ, from the second decoder 301. Thus, the output of the Softmax layer is then used in a beam search process to select orthographic elements to generate the speaker token 165. In some implementations, the Softmax layer is integrated with the second decoder 301, such that the output yₛ of the first decoder 300 represents the output of the Softmax layer. Moreover, the second decoder 301 may receive the blank logits 121 from the ASR model 200 (FIG. 1) such that the second decoder 301 only outputs speaker tokens 165 for non-blank logits.

Referring back to FIG. 1, the joint speech recognition and speaker diarization model 150 combines the speech recognition results 120 generated by the ASR model 200 and the speaker tokens 165 generated by the diarization model 160 to generate the diarization results 155. That is, the diarization results 155 indicate, for each respective term (e.g., word, wordpiece, and/or grapheme) of the speech recognition results 120 generated by the ASR model 200, an identity of the corresponding speaker 10 from the multiple speakers 10 that spoke the respective term of the speech recognition results 120. Thus, as the speech recognition results 120 include words, wordpieces, and/or graphemes, the diarization results 155 are similarly word-level, wordpiece-level, and/or grapheme-level, respectively.

Continuing with the example shown, the ASR model 200 recognizes word-level speech recognition results 120 of “How are you doing I am doing very well” and the diarization model 160 generates a corresponding speaker token 165 for each spoken word from the speech recognition results 120. In this example, the corresponding speaker tokens 165 indicate that the first speaker 10a spoke the words “How are you doing” and the second speaker 10b spoke the words “I am doing very well” during the conversation. Thus, by combining the speech recognition results 120 and the speaker tokens 165, the joint speech recognition and speaker diarization model 150 generates word-level diarization results 155 because the corresponding speech recognition results 120 output by the ASR model 200 are word-level. In some examples, the diarization model 160 the speaker token 165 includes speaker turn labels denoting the transition between speakers talking. For instance, the diarization results 155 include the speaker token 165 including the speaker turn label “<Speaker:1>” before the first speaker 10a starts speaking and the speaker token 165 including the speaker turn label “<Speaker:2>” as the second speaker 10b starts speaking. The diarization results 155 may be transmitted to the user devices 110 and displayed by graphical user interfaces of the user devices 110 for the speakers 10. Moreover, the diarization results 155 may be stored at the memory hardware 114, 146 for subsequent retrieval by one or more of the user devices 110.

FIG. 4 illustrates an example training process 400 for training the joint speech recognition and speaker diarization model 150 (FIG. 1). In particular, the training process 400 trains the ASR model 200 jointly with the diarization model 160. In some examples, the training process 400 trains the ASR model 200 by updating parameters of the ASR model 200 (e.g., parameters of the first decoder 300) based on a first loss 422 and trains the diarization model 160 by updating parameters of the diarization model 160 (e.g., parameters of the second decoder 301) based on a second loss 424. Thus, the first decoder 300 is trained to recognize terms spoken by the multiple speakers and the second decoder 301 is trained to predict/assign speaker tokens 165 for each spoken term.

In particular, the training process 400 obtains a series of segmented labeled training samples 410 whereby each segmented labeled training sample 410 includes one or more spoken terms (e.g., words, wordpieces, graphemes, etc.) 412 spoken during a conversation by multiple (e.g., two or more) speakers. Here, each respective spoken term 412 may be characterized by a corresponding sequence of acoustic frames 108 (FIG. 1). Moreover, each respective spoken term 412 is paired with a corresponding transcription (e.g., ground-truth transcription) 414 of the respective spoken term (e.g., word, wordpiece, grapheme, etc.) 412 and with a corresponding speaker label (e.g., ground-truth speaker token) 416 representing an identity of a speaker 10 that spoke the respective spoken term 412 during the conversation. For each respective segmented labeled training sample 410 of the series of segmented labeled training samples 410, the audio encoder 210 of the ASR model 200 generates (e.g., by the initial stack of the audio encoder layers 212 (FIG. 1)) a corresponding sequence of intermediate audio encodings 213 based on the respective segmented labeled training sample 410 and generates (e.g., by the remaining stack of the audio encoder layers 214 (FIG. 1)) a corresponding sequence of final audio encodings 215 based on the respective segmented labeled training sample 410. In particular, the ASR model 200 generates the intermediate audio encodings 213 and the final audio encodings 215 by processing the corresponding sequence of acoustic frames 108 (FIG. 1) characterizing the one or more spoken terms 412 included in the respective segmented labeled training sample 410. Thereafter, the first decoder 300 of the ASR model 200 generates a corresponding speech recognition result 120 including blank logits 121 (if any) based on the sequence of final audio encodings 215 generated by the audio encoder 210 for the respective segmented labeled training sample 410.

The diarization encoder 162 of the diarization model 160 obtains a corresponding dynamic audio cohort 500 associated with an immediately prior segmented labeled training sample 410. For example, for a first segmented labeled training sample 410 in the series of segmented labeled training samples 410, the diarization encoder 162 obtains a blank dynamic audio cohort 500 because there are no immediately prior segmented labeled training samples 410. In contrast, for a second segmented labeled training sample 410 in the series of segmented labeled training samples 410, the diarization encoder 162 obtains a corresponding dynamic audio cohort 500 generated by the diarization model 160 from the first segmented labeled training sample 410 (e.g., the immediately prior segmented labeled training sample 410). In some examples, the diarization encoder 162 may obtain a manually labeled dynamic audio cohort 500 during the training process 400 in addition to, or in lieu of, obtaining the dynamic audio cohort 500 generated by the diarization model 160 for an immediately preceding segmented labeled training sample 410. The dynamic audio cohort 500 includes a matrix of audio speech snippets 502 of speakers 10 that spoke prior to the respective segmented labeled training sample 410. The matrix of audio speech snippets 502 serves as a reference of speech samples of each speaker 10 that has previously spoken in the conversation. As such, the diarization model 160 uses the matrix of audio speech snippets 502 to determine who spoke each predicted term of the corresponding speech recognition result 120 by comparing audio data associated with each predicted term against the matrix of audio speech snippets 502.

FIG. 5 shows an example dynamic audio cohort 500 that includes a matrix of audio speech snippets 502. The matrix includes a predetermined number of slots 504 for each speaker 10 of the multiple speakers 10 that spoke during the conversation. Each respective slot 504 is configured to store a single audio speech snippet 502 for a respective one of the multiple speakers 10. Thus, the predetermined number of slots 504 represents a maximum number of audio speech snippets 502 that may be stored for any single speaker 10. In the example shown, the predetermined number of slots 504 includes three slots 504, 504a-c such that a maximum of three audio speech snippets 502 may be stored in association with each speaker 10 of the conversation. Notably, the dynamic audio cohort 500 includes audio-only data from the conversation. That is, the dynamic audio cohort 500 does not include discriminative speech embeddings or any other embeddings representing speech from any of the speakers 10. Moreover, each respective slot 504 is associated with a corresponding probability 506. In some examples, the probabilities 506 may increase exponentially with the slots 504. For instance, in the example shown, a first slot 504a of each speaker 10 is associated with a probability 506 of “0.001,” a second slot 504b of each speaker 10 is associated with a probability 506 of “0.01,” and a third slot 504c of each speaker 10 is associated with a probability 506 of “0.1.” As will become apparent, the diarization model 160 uses the probabilities 506 when updating the dynamic audio cohort 500.

Referring back to FIG. 4, the diarization encoder 162 generates a corresponding sequence of diarization encodings 163 based on the sequence of intermediate audio encodings 213 generated for the respective segmented labeled training sample 410 and the obtained dynamic audio cohort 500 associated with the immediately prior segmented labeled training sample 410. More specifically, the diarization encoder 162 generates the corresponding sequence of diarization encodings 163 by performing cross-attention on the respective segmented labeled training sample 410 and the corresponding dynamic audio cohort 500. For example, for the second segmented labeled training sample 410, the diarization encoder 162 performs cross-attention on the intermediate audio encodings 213 generated from the second segmented labeled training sample 410 and the dynamic audio cohort 500 associated with the first segmented labeled training sample 410.

The second decoder 301 generates a respective speaker token 165 representing the predicted identity of the speaker 10 that spoke each respective spoken term 412 included in the respective segmented labeled training sample 410 based on the sequence of diarization encodings 163. Moreover, the second decoder 301 updates the corresponding dynamic audio cohort 500 associated with the immediately prior segmented labeled training sample 410 based on the corresponding speech recognition results 120 and the corresponding speaker tokens 165 (e.g., collectively referred to as the diarization results 155 (FIG. 1)) associated with the current segmented labeled training sample 410. In some examples, the second decoder 301 determines that at least one of the one or more predicted terms of the corresponding speech recognition result 120 was spoken by a new speaker 10 that did not speak during any previous segmented labeled training sample 410 received so far. Since the at least one of the one or more predicted terms was spoken by the new speaker 10, the second decoder 301 determines that no audio speech snippets 502 are currently stored in association with the new speaker 10. In this example, based on determining that the at least one of the one or more predicted terms of the corresponding speech recognition result 120 was spoken by the new speaker 10, the second decoder 301 samples the corresponding sequence of acoustic frames 108 (FIG. 1) characterizing the at least one of the one or more predicted terms and stores the sampled corresponding sequence of acoustic frames as a respective audio speech snippet 502 for the new speaker 10 at one of the predetermined number of slots 504 (FIG. 5) for the new speaker. Sampling the corresponding sequence of acoustic frame 108 may include a subset of the sequence of acoustic frames 108 such that the subset of sequence of acoustic frames 108 serves as the audio speech snippet 502 rather than the entire sequence of acoustic frames 108.

In other examples, the second decoder 301 determines that at least one of the one or more predicted terms of the corresponding speech recognition result 120 was spoken by a respective speaker 10 that did speak (at least once) during a previous segmented labeled training sample 410. Since the at least one of the one or more predicted terms was spoken by a speaker that has previously spoken, the second decoder 301 determines that at least one audio speech snippet 502 is currently stored in association with the respective speaker 10. As such, continuing with the above example, the second decoder 301 whether a current number of audio speech snippets 502 stored for the respective speaker 10 satisfies a threshold of audio speech snippets. That is, the second decoder 301 determines whether the current number of audio speech snippets 502 stored in association with the respective speaker 10 exceeds the predetermined number of slots 504 (FIG. 5). Based on determining that the current number of audio speech snippets 502 fails to satisfy the threshold of audio speech snippets (e.g., the current number of audio speech snippets is less than the predetermined number of slots), the second decoder 301 samples the corresponding sequence of acoustic frames 108 (FIG. 1) characterizing the at least one of the one or more predicted terms and stores the sampled corresponding sequence of acoustic frames as a respective audio speech snippet 502 for the respective speaker 10 at one of the predetermined number of slots 504 (FIG. 5) is not currently storing an audio speech snippet 502.

Alternatively, based on determining that the current number of audio speech snippets 502 satisfies the threshold of audio speech snippets (e.g., the current number of audio speech snippets is equal to the predetermined number of slots), the second decoder 301 samples a random number from a random number distribution. For instance, the second decoder 302 may sample a random number from a distribution of random numbers from zero to one. Since the current number of audio speech snippets 502 is equal to the predetermined number of slots 504, the second decoder 301 determines that a maximum number of audio speech snippets 502 associated with the respective speaker 10 are already stored in the dynamic audio cohort 500. To that end, the second decoder 301 determines whether the sampled random number satisfies a random number threshold. More specifically, the second decoder 301 determines whether the sampled random number is less than at least one of the corresponding probabilities 506 (FIG. 5) associated with the predetermined number of slots 504. Based on determining that the sampled random number fails to satisfy the random number threshold (i.e., determining that the sampled random number is greater than each corresponding probabilities 506 (FIG. 5)), the second decoder 301 determines not to replace any of the audio speech snippets 502 currently stored in association with the respective speaker 10 with new audio data from the respective segmented labeled training sample 410.

On the other hand, based on determining that the sampled random number satisfies the random number threshold (i.e., determining that the sampled random number is less than at least one of the corresponding probabilities 506 (FIG. 5)), the second decoder 301 identifies a respective one of the predetermined number of slots 504 associated with the respective speaker 10 based on the sampled random number, samples the corresponding sequence of acoustic frames 108 (FIG. 1) characterizing the at least one of the one or more predicted terms of the corresponding speech recognition results 120, and replaces a respective audio speech snippet 502 stored at the identified respective one of the predetermined number of slots 504 with the sampled corresponding sequence of acoustic frames 108 as a new respective audio snippet. In some implementations, the identified the respective one of the predetermined number of slots 504 is associated with a corresponding probability 506 nearest to the sampled random number. Advantageously, identifying which slot 504 to replace the audio speech snippet 502 for based on the sampled random number prevents the diarization model 160 from simply replacing the oldest stored audio speech snippets 502 with new audio data such that the diarization model 160 stores audio speech snippets 502 representing speech variations of the respective speaker throughout the entire conversation.

Referring again to FIG. 5, the example dynamic audio cohort 500 shows the matrix of audio speech snippets 502 stored for four separate segmented labeled training samples 410. For a first segmented labeled training sample 410, 410a, the matrix of audio speech snippets 502 is blank because there are no prior segmented labeled training samples 410. In contrast, for a second segmented labeled training sample 410, 410b, the matrix of audio speech snippets 502 may include speech snippets stored from the first segmented labeled training sample 410a. Particularly, a first speaker 10a may have two first audio speech snippets 502, 502a (e.g., S1A and S1B) representing audio data of the first speaker 10a speaking during the first segmented labeled training sample 410a, and a second speaker 10b may have one second audio speech snippet 502, 502b (e.g., S2A) representing audio data of the second speaker 10b speaking during the first segmented labeled training sample 410a. A third segmented labeled training sample 410, 410c may include speech snippets stored from the first and second segmented labeled training samples 410a, 410b. That is, the first speaker 10a may now have three first audio speech snippets 502a (e.g., S1A, S1B, and S1C) representing audio data of the first speaker 10a speaking during the first and second segmented labeled training samples 410a, 410b, and the second speaker 10b may now have two second audio speech snippets 502b (e.g., S2A and S2B) representing audio data of the second speaker 10b speaking during the first and second segmented labeled training samples 410a, 410b. Notably, the matrix of audio speech snippets 502a stored in association with the first speaker 10a for the third segmented labeled training sample 410c is equal to the predetermined number of slots 504 of three. That is, the first speaker 10a has the maximum number of first audio speech snippets 502a stored in association with the first speaker 10a.

Continuing with the example shown, a fourth segmented labeled training sample 410, 410d includes audio speech snippets 502 stored from the first, second, and third segmented labeled training samples 410a-c. In particular, the second speaker 10b still has two second audio speech snippets 502b (e.g., S2A and S2B) representing audio data of the second speaker 10b speaking during the first and second segmented labeled training samples 410a, 410b, and a third speaker 10c has one third audio speech snippet 502, 502c (e.g., S3A) representing audio data of the third speaker 10c speaking during the third segmented labeled training sample 410c. Notably, the first speaker 10a still has two first audio speech snippets 502a (e.g., S1A, S1D, and S1C) stored in association with the first speaker 10a, but the first audio speech snippet 502a previously stored at a second slot 504b (e.g., S1B) is replaced with a new first audio speech snippet 502a (e.g., S1D).

Rather than naively replacing the oldest (e.g., Si A) or most recent (e.g., SIC) first audio speech snippet 502a, the second decoder 301 samples a random number from the random number distribution and compares the sampled random number to the probabilities 506 associated with the predetermined number of slots 504. For instance, the second decoder 301 may sample a random number between zero and one of 0.009 and compare the sampled random number to the probabilities 506 associated with the predetermined number of slots 504. In particular, the second decoder 301 determines that 0.009 is less than the associated probability of the second slot 504b and the third slot 504c. Based on this determination, the second decoder 301 identifies the probability 506 of 0.01 associated with the second slot 504b as being nearest the sampled random number as 0.009. As such, the second decoder 301 replaces the first audio speech snippet 502a (e.g., S1B) representing audio data spoken during the first segmented labeled training sample 410a currently stored at the second slot 504b with a new first audio speech snippet 502a (e.g., S1D) representing audio data spoken during the third segmented labeled training sample 410c. The process of updating the dynamic audio cohort 500 may similarly be applied during inference whereby the diarization model 160 processes segments of the series of acoustic frames 108 in lieu of the segmented labeled training samples 410.

Referring back to FIG. 4, the training process 400 also includes a loss module 420 that determines the first loss 422 and the second loss 424 for training the ASR model 200 and the diarization model 160 of the joint speech recognition and speaker diarization model 150 (FIG. 1). In particular, the loss module 420 receives the speech recognition results 120 generated by the ASR model 200 for each respective segmented labeled training sample 410 and the corresponding transcriptions 414, and determines the first loss (e.g., word error rate (WER) loss) 422 by comparing the speech recognition results 120 and the corresponding transcription 414 for each respective spoken term 412 included in the respective segmented labeled training sample 410. In some examples, the training process 400 back-propagates the first loss 422 to the ASR model 200 and updates parameters of the ASR model 200 based on the first loss 422 determined for each respective segmented labeled training sample 410 of the series of segmented labeled training samples 410.

In some implementations, the loss module 420 receives the speaker tokens 165 generated by the diarization model 160 for each respective segmented labeled training sample 410 and the corresponding speaker labels 516, and determines the second loss (e.g., diarization loss) 424 by comparing the speaker tokens 165 with the corresponding speaker labels 416 for each of the spoken terms 412 included in the respective segmented labeled training sample 410. In other implementations, the loss module 420 determines the second loss (e.g., word diarization error rate (WDER) loss) 424 according to:

$$WDER = \frac{{S}_{IS} + {C}_{IS}}{S + C} \qquad ( 1 )$$

In Equation 1, S_{IS} represents a number of speech recognition result substitutions with incorrect speaker tokens, C_{IS} represents a number of correct speech recognition results with incorrect speaker tokens, S represents a number of speech recognition result substitutions, and C represents a number of correct speech recognition results. The training process 400 may back-propagate the second loss 424 to the diarization model 160 and update parameters of the diarization model 160 based on the second loss 424 determined for each respective segmented labeled training sample 410 of the series of segmented labeled training samples 410. The training process 400 trains the ASR model 200 based on the first loss 422 jointly with training the diarization model 160 based on the second loss 424. Notably, neither the first loss 422 nor the second loss 424 is derived based on the dynamic audio cohort 500. Instead, the training process 400 uses the dynamic audio cohort 500 to predict more accurate speaker tokens 165 while training the diarization model 160.

In some scenarios, however, the amount of labeled training data needed for the training process 400 to train the joint speech recognition and speaker diarization model 150 is unavailable and/or expensive to obtain. In these scenarios, using a relatively small amount of labeled training data or using low-quality labeled training data leads to the joint speech recognition and diarization model having degraded performance during inference or overfitting the limited amount of training data. In particular, low-quality labeled training data may refer to training data that has misrecognized or missing terms from the conversation or has incorrect or missing speaker labels. As such, in some examples, the training process 400 augments the segmented labeled training samples 410. For example, for an initial segmented labeled training sample 410 of “<spk1> hello <spk2> how are you,” the dynamic audio cohort 500 associated with the immediately prior sample is blank because there are no prior samples. Thus, the training process 400 may augment the initial segmented labeled training sample 410 by adding audio speech snippets from other training samples to fill the dynamic audio cohort 500 used while processing the initial segmented labeled training sample 410.

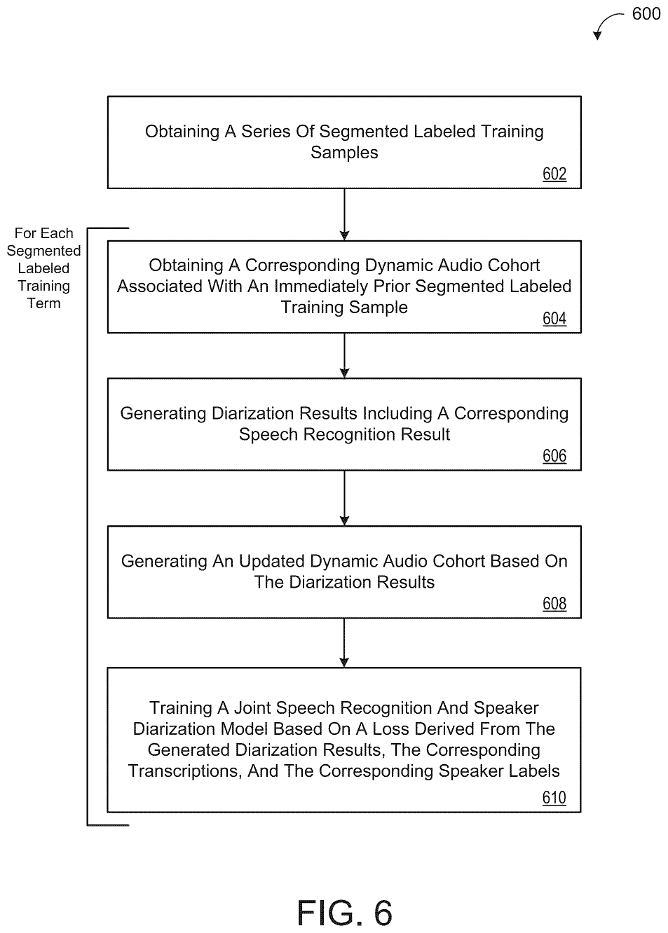

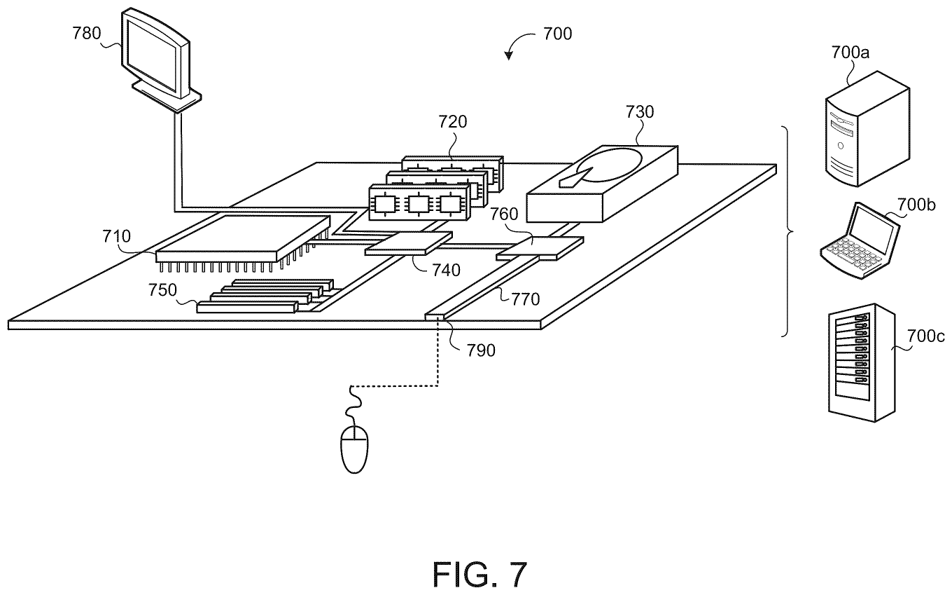

FIG. 6 includes a flowchart of an example arrangement of operations for a computer-implemented method of training an end-to-end speaker diarization model with a dynamic audio cohort. The method 600 may execute on data processing hardware 710 (FIG. 7) using instructions stored on memory hardware 720 (FIG. 7) that may reside on the user device 110 and/or the remote system 140 of FIG. 1 each corresponding to a computing device 700 (FIG. 7).

At operation 602, the method 600 includes obtaining a series of segmented labeled training samples 410. Each respective segmented labeled training sample 410 includes one or more spoken terms 412 spoken during a conversation by multiple speakers 10. Each respective spoken term 412 is characterized by a corresponding sequence of acoustic frames 108 and is paired with a corresponding transcription 414 of the respective spoken term 412 and a corresponding speaker label 416 representing an identity of a respective speaker 10 that spoke the respective spoken term 412 during the conversation. For each respective segmented labeled training sample 410, the method 600 performs operations 604-610. At operation 604, the method 600 includes obtaining corresponding dynamic audio cohort 500 associated with an immediately prior segmented labeled training sample 410. The corresponding dynamic audio cohort 500 includes a matrix of audio speech snippets 502 of speakers 10 that spoke prior to the respective segmented labeled training sample 410. At operation 606, the method 600 includes generating diarization results 155 that include a corresponding speech recognition result 120 including one or more predicted terms. The diarization results 155 are generated as output from a joint speech recognition and speaker diarization model 150 by performing cross-attention on the respective segmented labeled training sample 410 and the corresponding dynamic audio cohort 500. Each respective predicted term of the corresponding speech recognition result 120 is associated with a corresponding speaker token 165 representing a predicted identity of a speaker 10 that spoke the respective predicted term. At operation 608, the method 600 includes generating an updated dynamic audio cohort 500 based on the diarization results 155. The updated dynamic audio cohort 500 is used for a subsequent segmented labeled training sample 410. At operation 610, the method 600 includes training the joint speech recognition and speaker diarization model 150 based on a loss 422, 424 derived from the generated diarization results 155, the corresponding transcriptions 414, and the corresponding speaker labels 416.

Traditional ASR systems often struggle with accurately recognizing speech in environments where multiple speakers are present, as these systems typically assume only one speaker is speaking at any given time. This limitation may lead to inaccurate speech recognition results, especially in complex audio streams with overlapping speech. The joint speech recognition and diarization model 150 addresses this challenge by operating at the word level, thereby enhancing the accuracy of both speech recognition and speaker identification. The joint speech recognition and diarization model 150 dynamically updates a matrix of audio speech snippets, referred to as the dynamic audio cohort 500, which represents the speech characteristics of multiple speakers 100 throughout a conversation. Unlike existing systems that rely on static speaker-discriminative embeddings, this dynamic approach allows the model to adapt to variations in a speaker's voice over time, such as changes in tone, pitch, or speaking style. This adaptability ensures that the model can more accurately identify speakers 10 even as their speech patterns evolve during a conversation, leading to more reliable diarization results. 155, 175.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining a series of segmented labeled training samples, each respective segmented labeled training sample comprising one or more spoken terms spoken during a conversation by multiple speakers, each respective spoken term characterized by a corresponding sequence of acoustic frames and paired with a corresponding transcription of the respective spoken term and a corresponding speaker label representing an identity of a respective speaker that spoke the respective spoken term during the conversation; and
for each respective segmented labeled training sample:
obtaining a corresponding dynamic audio cohort associated with an immediately prior segmented labeled training sample, the corresponding dynamic audio cohort comprising a matrix of audio speech snippets of speakers that spoke prior to the respective segmented labeled training sample;
generating, as output from a joint speech recognition and speaker diarization model, by performing cross-attention on the respective segmented labeled training sample and the corresponding dynamic audio cohort, diarization results comprising a corresponding speech recognition result comprising one or more predicted terms, each respective predicted term associated with a corresponding speaker token representing a predicted identity of a speaker that spoke the respective predicted term;
generating an updated dynamic audio cohort based on the diarization results; and
training the joint speech recognition and speaker diarization model based on a loss derived from the generated diarization results, the corresponding transcriptions, and the corresponding speaker labels.

2. The computer-implemented method of claim 1, wherein the matrix of audio speech snippets comprises audio-only data.

3. The computer-implemented method of claim 1, wherein the matrix of audio speech snippets comprises a predetermined number of slots for each speaker of the multiple speakers that spoke during the conversation, each respective slot configured to store a single audio speech snippet for a respective one of the multiple speakers.

4. The computer-implemented method of claim 3, wherein each respective slot of the predetermined number of slots is associated with a corresponding probability.

5. The computer-implemented method of claim 4, wherein generating the updated dynamic audio cohort based on the diarization results comprises:
determining that at least one of the one or more predicted terms of the corresponding speech recognition result was spoken by a new speaker that did not speak during any previous segmented labeled training sample;
based on determining that the at least one of the one or more predicted terms of the corresponding speech recognition result was spoken by the new speaker, sampling the corresponding sequence of acoustic frames characterizing the at least one of the one or more predicted terms; and
storing the sampled corresponding sequence of acoustic frames as a respective audio speech snippet for the new speaker at one of the predetermined number of slots for the new speaker.

6. The computer-implemented method of claim 4, wherein generating the updated dynamic audio cohort based on the diarization results comprises:
determining that at least one of the one or more predicted terms of the corresponding speech recognition result was spoken by a respective speaker that did speak during a previous segmented labeled training sample;
determining that a current number of audio speech snippets stored for the respective speaker fails to satisfy a threshold of audio speech snippets;
based on determining that the current number of snippets stored for the respective speaker fails to satisfy the threshold of audio speech snippets, sampling the corresponding sequence of acoustic frames characterizing the at least one of the one or more predicted terms; and
storing the sampled corresponding sequence of acoustic frames as a respective audio snippet for the respective speaker at one of the predetermined number of slots.

7. The computer-implemented method of claim 4, wherein generating the updated dynamic audio cohort based on the diarization results comprises:
determining that at least one of the one or more predicted terms of the corresponding speech recognition result was spoken by a respective speaker that did speak during a previous segmented labeled training sample;
determining that a current number of snippets stored for respective speaker satisfies a threshold of audio speech snippets; and
based on determining that the current number of snippets stored for respective speaker satisfies the threshold of audio speech snippets, sampling a random number from a random number distribution.

8. The computer-implemented method of claim 7, wherein generating the updated dynamic audio cohort based on the diarization results comprises:
determining that the sampled random number satisfies a random number threshold; and
based on determining that the sampled random number satisfies the random number threshold:
identifying a respective one of the predetermined number of slots associated with the respective speaker based on the sampled random number;
sampling the corresponding sequence of acoustic frames characterizing the at least one of the one or more predicted terms; and
replacing a respective audio speech snippet stored at the identified respective one of the predetermined number of slots with the sampled corresponding sequence of acoustic frames as a new respective audio snippet.

9. The computer-implemented method of claim 7, wherein generating the updated dynamic audio cohort based on the diarization results comprises:
determining that the sampled random number fails to satisfy a random number threshold; and
based on determining that the sampled random number fails to satisfy the random number threshold, determining not to replace any of the audio speech snippets currently stored in association with the respective speaker.

10. The computer-implemented method of claim 1, wherein the operations further comprise augmenting each segmented labeled training sample.

11. A system comprising:
data processing hardware;
memory hardware in communication with the data processing hardware, the memory hardware storing instruction that when executed on the data processing hardware cause the data processing hardware to perform operations comprising:
obtaining a series of segmented labeled training samples, each respective segmented labeled training sample comprising one or more spoken terms spoken during a conversation by multiple speakers, each respective spoken term characterized by a corresponding sequence of acoustic frames and paired with a corresponding transcription of the respective spoken term and a corresponding speaker label representing an identity of a respective speaker that spoke the respective spoken term during the conversation; and
for each respective segmented labeled training sample:
obtaining a corresponding dynamic audio cohort associated with an immediately prior segmented labeled training sample, the corresponding dynamic audio cohort comprising a matrix of audio speech snippets of speakers that spoke prior to the respective segmented labeled training sample;
generating, as output from a joint speech recognition and speaker diarization model, by performing cross-attention on the respective segmented labeled training sample and the corresponding dynamic audio cohort, diarization results comprising a corresponding speech recognition result comprising one or more predicted terms, each respective predicted term associated with a corresponding speaker token representing a predicted identity of a speaker that spoke the respective predicted term;
generating an updated dynamic audio cohort based on the diarization results; and
training the joint speech recognition and speaker diarization model based on a loss derived from the generated diarization results, the corresponding transcriptions, and the corresponding speaker labels.

12. The system of claim 11, wherein the matrix of audio speech snippets comprises audio-only data.

13. The system of claim 11, wherein the matrix of audio speech snippets comprises a predetermined number of slots for each speaker of the multiple speakers that spoke during the conversation, each respective slot configured to store a single audio speech snippet for a respective one of the multiple speakers.

14. The system of claim 13, wherein each respective slot of the predetermined number of slots is associated with a corresponding probability.

15. The system of claim 14, wherein generating the updated dynamic audio cohort based on the diarization results comprises:
determining that at least one of the one or more predicted terms of the corresponding speech recognition result was spoken by a new speaker that did not speak during any previous segmented labeled training sample;
based on determining that the at least one of the one or more predicted terms of the corresponding speech recognition result was spoken by the new speaker, sampling the corresponding sequence of acoustic frames characterizing the at least one of the one or more predicted terms; and
storing the sampled corresponding sequence of acoustic frames as a respective audio speech snippet for the new speaker at one of the predetermined number of slots for the new speaker.

16. The system of claim 14, wherein generating the updated dynamic audio cohort based on the diarization results comprises:
determining that at least one of the one or more predicted terms of the corresponding speech recognition result was spoken by a respective speaker that did speak during a previous segmented labeled training sample;
determining that a current number of audio speech snippets stored for the respective speaker fails to satisfy a threshold of audio speech snippets;
based on determining that the current number of snippets stored for the respective speaker fails to satisfy the threshold of audio speech snippets, sampling the corresponding sequence of acoustic frames characterizing the at least one of the one or more predicted terms; and
storing the sampled corresponding sequence of acoustic frames as a respective audio snippet for the respective speaker at one of the predetermined number of slots.

17. The system of claim 14, wherein generating the updated dynamic audio cohort based on the diarization results comprises:
determining that at least one of the one or more predicted terms of the corresponding speech recognition result was spoken by a respective speaker that did speak during a previous segmented labeled training sample;
determining that a current number of snippets stored for respective speaker satisfies a threshold of audio speech snippets; and
based on determining that the current number of snippets stored for respective speaker satisfies the threshold of audio speech snippets, sampling a random number from a random number distribution.

18. The system of claim 17, wherein generating the updated dynamic audio cohort based on the diarization results comprises:
determining that the sampled random number satisfies a random number threshold; and
based on determining that the sampled random number satisfies the random number threshold:
identifying a respective one of the predetermined number of slots associated with the respective speaker based on the sampled random number;
sampling the corresponding sequence of acoustic frames characterizing the at least one of the one or more predicted terms; and
replacing a respective audio speech snippet stored at the identified respective one of the predetermined number of slots with the sampled corresponding sequence of acoustic frames as a new respective audio snippet.

19. The system of claim 17, wherein generating the updated dynamic audio cohort based on the diarization results comprises:
determining that the sampled random number fails to satisfy a random number threshold; and
based on determining that the sampled random number fails to satisfy the random number threshold, determining not to replace any of the audio speech snippets currently stored in association with the respective speaker.

20. The system of claim 11, wherein the operations further comprise augmenting each segmented labeled training sample.
